(19) United States
(12) Patent Application Publication
(10) Pub. No.: US 2004/0243402 A1
(43) Pub. Date: Dec. 2, 2004

(54) Speech bandwidth extension apparatus and speech bandwidth extension method

(76) Inventor: Kazunori Ozawa, Tokyo (JP)

Correspondence Address: OSTROLENK FABER GERB & SOFFEN, 1180 AVENUE OF THE AMERICAS, NEW YORK, NY, 100368403

(21) Appl. No.: 10/484,936

(22) PCT Filed: Jul. 26, 2002
(86) PCT No.: PCT/JP02/07605

(30) Foreign Application Priority Data
Jul. 26, 2001 (JP) 2001-226751

(51) Int. Cl. G10L 11/06

(52) U.S. Cl. 704/208

(57) ABSTRACT

The spectrum parameter calculator circuit 100 divides a decoded reproduction speech signal into frames and computes a spectrum parameter for each frame. The coefficient calculator circuit 130 shifts a frequency of the spectrum parameter to higher one, and then determines a filter coefficient extended in frequency bandwidth to output it to the composition filter circuit 170. The adder 160 outputs a sound-source signal, which results from addition of a noise signal having a duration equal to the frame length and an adaptive code vector based on a past sound-source signal, to the composition filter circuit 170. The adder 190 uses a sound-source signal extended in frequency bandwidth and adds the signal to a signal resulting from conversion of the reproduction speech signal with a sampling frequency having a higher frequency component to reproduce and output a speech signal extended in frequency bandwidth.

### TECHNICAL FIELD

The present invention relates to a speech bandwidth extension apparatus, and more specifically to a speech bandwidth extension apparatus which extends a reproduction frequency bandwidth after the decode of a speech signal coded at a low bit rate to improve the audible timbre.

### BACKGROUND ART

Conventionally, there has been known, as a speech bandwidth extension scheme, a scheme for extending a frequency bandwidth in which a speech signal coded at a low bit rate is reproduced at a receiving end without transmitting additional information relating to the bandwidth extension from the transmitting end. For example, there has been known the paper by P. Jax and P. Vary, “Wideband extension of telephone speech using hidden markov model”, Proc. IEEE Speech Coding Workshop, pp. 133-135, 2000.

The conventional scheme implemented the modeling of the spectrum envelope of broad bandwidth speeches and the filter coefficients hereof according to HMM model (Hidden Markov Model), therefore it required previously deciding HMM model parameters offline based on large volumes of database. In order to carry out an extension process of a frequency bandwidth in real time at a receiving end, it also required large amounts of calculations for the retrieval according to the HMM model.

The foregoing conventional speech bandwidth extension apparatus poses a problem that decision of HMM model parameters requires referring to large volumes of database. Also, the apparatus has a disadvantage such that it requires large amounts of calculations for the retrieval according to the HMM model in order to carry out an extension process of a frequency bandwidth in real time at a receiving end.

It is an object of the invention to provide a speech bandwidth extension apparatus by which a voice with a good timbre extended in frequency bandwidth can be obtained by relatively small amounts of calculations without receiving additional information from a transmitting end. The object is achieved by: dividing an entered reproduction speech signal into frames; shifting the frequency of a spectrum parameter determined for each frame; configuring a synthesis filter with a linear prediction coefficient extended in bandwidth; and using a sound-source signal passed through the synthesis filter to reproduce the reproduction speech signal in a speech signal extended in bandwidth.

### DISCLOSURE OF THE INVENTION

The speech bandwidth extension apparatus of the invention is characterized by including: a spectrum parameter calculator circuit which receives an entry of a decoded reproduction speech signal and calculates a spectrum parameter indicative of a spectrum characteristic; a coefficient calculator circuit which shifts a frequency of said spectrum parameter to higher one and then determines a filter coefficient extended in frequency bandwidth; a voice/voiceless judging circuit which receives an entry of said reproduction speech signal and outputs voice/voiceless judging information and a pitch cycle; a gain adjusting circuit which outputs a gain based on said voice/voiceless judging information; a fixed codebook circuit which receives an entry of said pitch cycle and generates an adaptive code vector based on a past sound-source signal; a noise generator circuit which generates a noise signal limited in bandwidth; a gain circuit which receives entries of said adaptive code vector and said noise signal and assigns at least one of them a proper gain; a first adder which adds outputs of said gain circuit to output a sound-source signal; a composition filter circuit which passes said sound-source signal through a synthesis filter configured with said filter coefficient to output a sound-source signal extended in frequency bandwidth; a sampling frequency converter circuit which receives an entry of said reproduction speech signal and outputs a signal resulting from conversion with a predetermined sampling frequency; and a second adder which adds an output of said sampling frequency converter circuit and an output of said composition filter circuit to output a reproduction speech signal extended in bandwidth.

Also, the speech bandwidth extension apparatus of the invention is characterized by including, a spectrum parameter calculator circuit which receives an entry of a decoded reproduction speech signal and calculates a spectrum parameter indicative of a spectrum characteristic; a coefficient calculator circuit which shifts a frequency of said spectrum parameter to higher one and then determines a filter coefficient extended in frequency bandwidth; a voice/voiceless judging circuit which receives an entry of said reproduction speech signal and outputs voice/voiceless judging information; a gain adjusting circuit which outputs a gain based on said voice/voiceless judging information; a noise generator circuit which generates a noise signal limited in bandwidth; a gain circuit which receives an entry of said noise signal and outputs a sound-source signal resulting from assignment of a proper gain; a composition filter circuit which passes said sound-source signal through a synthesis filter configured with said filter coefficient to output a sound-source signal extended in frequency bandwidth; a sampling frequency converter circuit which receives an entry of said reproduction speech signal and outputs a signal resulting from conversion with a predetermined sampling frequency; and an adder which adds an output of said sampling frequency converter circuit and an output of said composition filter circuit to output a reproduction speech signal extended in bandwidth.

It is characterized in that said spectrum parameter calculator circuit divides said reproduction speech signal into frames and then calculates and outputs said spectrum parameter indicative of a spectrum characteristic for each frame up to a predetermined order.

Also, it is characterized in that said coefficient calculator circuit shifts a frequency of said spectrum parameter to higher one and then converts the resultant spectrum parameter into a filter coefficient (linear prediction coefficient) having a predetermined order to output the filter coefficient.

It is also characterized in that the fixed codebook circuit receives an entry of said pitch cycle and outputs an adaptive code vector for an adaptive codebook based on a past sound-source signal for each frame.

It is also characterized in that said noise generator circuit outputs a noise signal which is limited in frequency bandwidth and normalized at a level predetermined in average amplitude and which has a duration equal to a frame length.

The speech bandwidth extension method of the invention is a speech bandwidth extension method of extending a frequency bandwidth of a decoded reproduction speech signal characterized by dividing an entered reproduction speech signal into frames; shifting a frequency of a spectrum parameter determined for each frame to higher one and then converting the resultant spectrum parameter into a filter coefficient (linear prediction coefficient) extended in frequency bandwidth; passing a sound-source signal resulting from addition of a noise signal having a duration equal to a frame length and an adaptive code vector based on a past sound-source signal through a synthesis filter configured with said filter coefficient to make a sound-source signal extended in frequency bandwidth; and adding said extended sound-source signal to a signal resulting from conversion of said reproduction speech signal with a sampling frequency having a higher frequency component, thereby to reproduce a speech signal extended in frequency bandwidth.

### BRIEF DESCRIPTION OF THE DRAWINGS

FIG. 1 is a block diagram showing a form of the speech bandwidth extension apparatus of the invention.

FIG. 2 is a block diagram showing another form of the speech bandwidth extension apparatus of the invention.

FIG. 3 is a block diagram showing another form of the speech bandwidth extension apparatus of the invention.

### BEST MODE FOR CARRYING OUT THE INVENTION

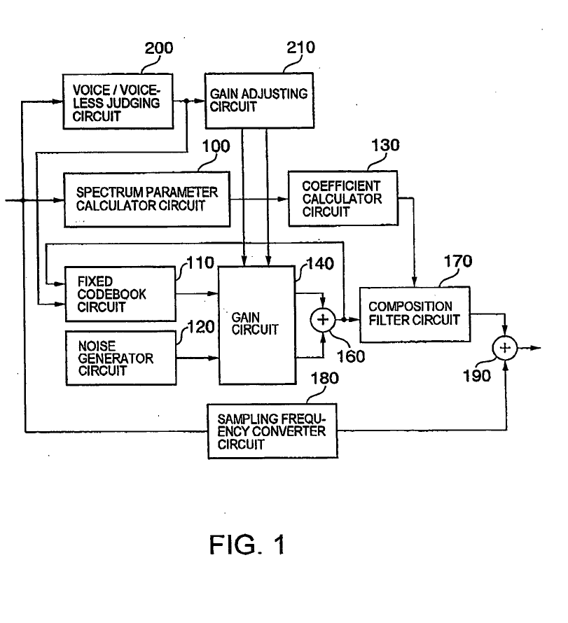

Now, the embodiments of the invention will be described in reference to the drawings. FIG. 1 is a block diagram showing a form of the speech bandwidth extension apparatus of the invention.

The embodiment shown in FIG. 1 includes:

a spectrum parameter calculator circuit 100 which receives an entry of a decoded reproduction speech signal and calculates a spectrum parameter indicative of a spectrum characteristic;

a coefficient calculator circuit 130 which shifts a frequency of the spectrum parameter to higher one and then determines a filter coefficient extended in frequency bandwidth;

a voice/voiceless judging circuit 200 which receives an entry of the reproduction speech signal and outputs voice/voiceless judging information and a pitch cycle;

a gain adjusting circuit 210 which outputs a gain based on the voice/voiceless judging information;

a fixed codebook circuit 110 which receives an entry of the pitch cycle and generates an adaptive code vector based on a past sound-source signal;

a noise generator circuit 120 which generates a noise signal limited in bandwidth;

a gain circuit 140 which receives entries of the adaptive code vector and noise signal and assigns at least one of them a proper gain;

an adder 160 which adds outputs of the gain circuit 140 to output a sound-source signal;

a composition filter circuit 170 which passes the sound-source signal through a synthesis filter configured with the filter coefficient to output a sound-source signal extended in frequency bandwidth;

a sampling frequency converter circuit 180 which receives an entry of the reproduction speech signal and outputs a signal resulting from conversion with a predetermined sampling frequency; and

an adder 190 which adds the outputs of the sampling frequency converter circuit 180 and composition filter circuit 170 to output a reproduction signal extended in bandwidth.

Now, the operation of the speech bandwidth extension apparatus of the embodiment will be described in detail in reference to FIG. 1. In the following description, it is assumed that extending a frequency bandwidth means extending the frequency bandwidth of entered reproduction speech signals from 4 to 5 or 7 kHz.

Referring to FIG. 1, wherein the spectrum parameter calculator circuit 100 receives an entry of a decoded reproduction speech signal, divides the speech signal into frames (e.g. 10 ms) and then calculates a spectrum parameter indicative of a spectrum characteristic for each of the frames up to a predetermined order (e.g. P=10) to output it to the coefficient calculator circuit 130.

Here, the well-known LPC(Linear Predictive Coding) analysis or Burg analysis may be used to calculate the spectrum parameter. In this embodiment, the Burg analysis is used. Detailed description of the Burg analysis is omitted because it is found in the book by Nakamizo, “SHINGO-KAISEKI TO SISUTEMU-DOHTEI (SIGNAL ANALYSIS AND SYSTEM IDENTIFICATION),” pp. 82-87, etc., Corona Publishing Co., Ltd., 1988

Further, the spectrum parameter calculator circuit 100 outputs a linear prediction coefficient αi(i=1, . . . P) calculated according to the Burg method in a form converted into an LSP parameter suitable for quantization and interpolation.

Here, in regard to the conversion from a linear prediction coefficient into a LSP parameter, reference may be made to the paper by Sugamura et al., “Sen-supekutoru tsui (LSP) onsei-bunseki-gousei-houshiki ni yoru onsei-jouhou assyuku (Speech Information Compression by Line Spectrum Pair (LSP) Speech Analysis and Synthesis),” J. of IECEJ, J64-A, pp. 599-606, 1981.

The coefficient calculator circuit 130 receives an entry of the LSP parameter output from the spectrum parameter calculator circuit 100, converts the LSP parameter into a coefficient of the signal extended in frequency bandwidth, and outputs the coefficient to the composition filter circuit 170. For this conversion, it is possible to use a well-known method, e.g. a technique to simply shift an LSP parameter frequency to higher one, a nonlinear conversion technique, or a linear conversion technique. All or part of LSP parameters is used here to shift the frequency of the LSP parameter to higher one, and then to convert it into a linear prediction coefficient (filter coefficient) having a predetermined order of M.

The voice/voiceless judging circuit 200 receives an entry of a decoded reproduction speech signal, judges that the signal for each frame is voiced or unvoiced. A concrete judging method will be described below. The signal for each frame is judged to be a voiced portion in the case of the maximum value of a normalized autocorrelation function D(T) larger than a predetermined threshold; it is judged to be an unvoiced portion in the case of the maximum value less than the threshold. The normalized autocorrelation function D(T) with respect to the reproduction speech signal x(n) until a predetermined delay time of m is calculated according to a mathematical expression (1) shown by Number 1 below. The judged voice/voiceless judging information is output to the gain adjusting circuit 210. Further, the signal for each frame of the voiced portion is output to the fixed codebook circuit 110 with its pitch cycle T taken to be a value of T such that the normalized autocorrelation function D(T) is maximized. Incidentally, N in the mathematical expression (1) is a sample number for calculation of a normalized autocorrelation.

$$D ( T ) = [ {\sum }_{n = 0}^{N - 1} x ( n ) x ( n - T ) ] / [ {\sum }_{n = 0}^{N - 1} {X}^{2} ( n - T ) ] \qquad ( 1 )$$

The gain adjusting circuit 210 receives an entry of the voice/voiceless judging information from the voice/voiceless judging circuit 200, outputs a gain for an adaptive codebook signal and a gain for a noise signal to the gain circuit 140 depending on whether the information is one of a voiced portion or an unvoiced portion.

The fixed codebook circuit 110 receives an entry of the pitch cycle of the adaptive codebook from voice/voiceless judging circuit 200, and creates and outputs an adaptive code vector. The fixed codebook circuit 110 also creates an adaptive codebook component.

The noise generator circuit 120 generates a noise signal, limited in frequency bandwidth, normalized at a level predetermined in average amplitude, and having a duration equal to the frame length, and outputs the resultant noise signal to the gain circuit 140. Although a white noise is used here as the noise signal for instance, it is also possible to use a noise signal having another statistical distribution.

The gain circuit 140 receives entries of the gain for the adaptive codebook signal and the gain for the noise signal output from the gain adjusting circuit 210, multiplies at least one of the adaptive code vector output from the fixed codebook circuit 110 and the noise signal output from the noise generator circuit 120 by a proper gain and then outputs the respective signals to the adder 160.

The adder 160 outputs a sound-source signal resulting from addition of the two kinds of signals outputs from the gain circuit 140 to the composition filter circuit 170 and the fixed codebook circuit 110.

The composition filter circuit 170 is composed of a synthesis filter in response to an entry of the linear prediction coefficient (filter coefficient) of the order M output from the coefficient calculator circuit 130. The composition filter circuit 170 receives an entry of the sound-source signal output from the adder 160 and outputs a sound-source signal extended in frequency bandwidth.

The sampling frequency converter circuit 180, receives an entry of the reproduction speech signal, and outputs a signal resulting from conversion with a predetermined integral multiple of sampling frequency. The signal resulting from the conversion keeps the component that the signal has held prior to the frequency extension.

The adder 190 adds the signal output from the sampling frequency converter circuit 180 and the sound-source signal output from the composition filter circuit 170 to form and output a reproduction speech signal extended in frequency bandwidth.

According to the embodiment, there is neither need to receive the information for bandwidth extension from a transmitting end nor need to perform large amounts of calculations based on HMM as in the conventional technique because of: dividing an entered reproduction speech signal into frames;

shifting the frequency of a spectrum parameter or an LSP parameter determined for each frame to higher one;

then converting the parameter into a filter coefficient (linear prediction coefficient) extended in frequency bandwidth;

passing a sound-source signal, which results from addition of a noise signal having a duration equal to the frame length and an adaptive code vector based on a past sound-source signal, through a synthesis filter configured with the filter coefficient to make a sound-source signal extended in frequency bandwidth; and

adding the sound-source signal extended in frequency bandwidth to a signal resulting from conversion of an entered reproduction speech signal with a sampling frequency having a higher frequency component,

thereby to reproduce a speech signal extended in frequency bandwidth.

Further, the processing can be performed extremely easily because a white noise or the like is used as a sound-source information.

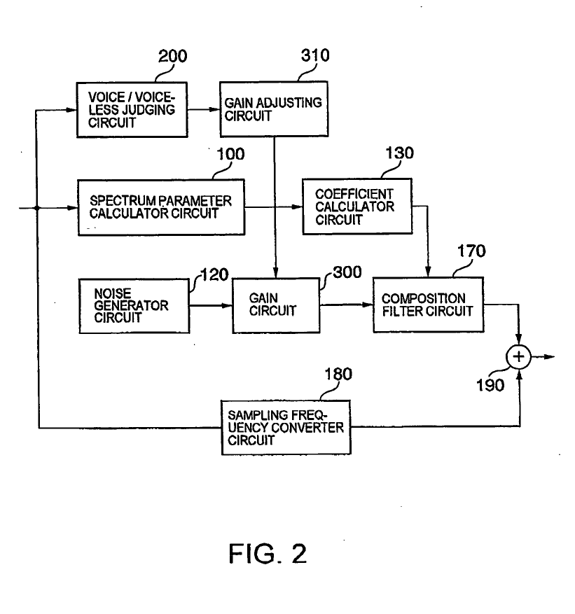

Next, another embodiment of the invention will be described. FIG. 2 is a block diagram showing another form of the speech bandwidth extension apparatus of the invention. Descriptions about constituent elements identified by the same numerals as those in FIG. 1 are omitted because the elements operate in the same manner as those in FIG. 1.

In FIG. 2, the gain adjusting circuit 310 receives an entry of the voice/voiceless judging information from the voice/voiceless judging circuit 200 and outputs a signal for adjusting the gain of a noise signal to the gain circuit 300 depending on whether the information is one of a voiced portion or an unvoiced portion.

The gain circuit 300 receives an entry of the gain of the noise signal output from the gain adjusting circuit 310 and outputs a signal resulting from multiplying the gain by the noise signal output from the noise generator circuit 120 to the composition filter circuit 170.

Here, the fixed codebook circuit 110 shown in FIG. 1 is used to generate a periodical component to be contained in a vowel sound, etc. of a speech signal. In addition, the vowel sound signal is generally said not to extend to a higher frequency and as such, it may be omitted in a speech bandwidth extension apparatus. Therefore, dismounting the fixed codebook circuit 110 can reduce data processing amounts.

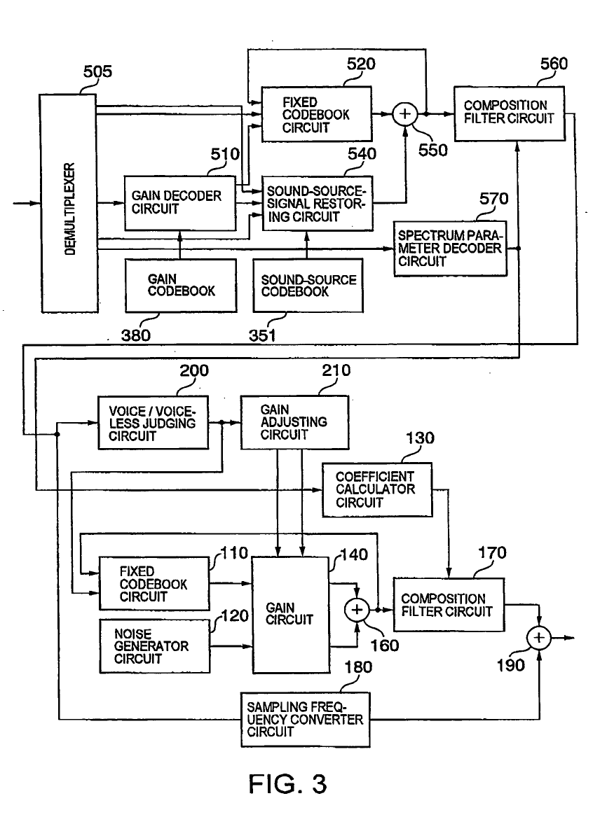

Now, still another embodiment of the invention will be described. FIG. 3 is a block diagram showing another form of the speech bandwidth extension apparatus of the invention.

As shown in FIG. 3, a speech bandwidth extension apparatus according to the above embodiment has a configuration such that in a preceding stage thereof is located a speech decoder composed of a demultiplexer 505, a gain decoder circuit 510, a fixed codebook circuit 520, a sound-source-signal restoring circuit 540, a spectrum parameter decoder circuit 570, an adder 550, a composition filter circuit 560, a gain codebook 380, and a sound-source codebook 351.

Here, the spectrum parameter decoder circuit 570 also serves as the spectrum parameter calculator circuit 100 shown in FIG. 1 in is operation. This makes the configuration simplified. Descriptions about constituent elements identified by the same numerals as those in FIG. 1 are omitted here because the elements operate in the same manner as those in FIG. 1.

In FIG. 3, the demultiplexer 505 separates from a received signal the multiplexed parameters as speech information, i.e. an index showing a gain code vector, an index showing a delay of an adaptive codebook, information on a sound-source signal, and an index of a sound-source code vector and an index of a spectrum parameter, and outputs them.

The gain decoder circuit 510 receives an entry of an index showing a gain code vector, reads out a gain code vector from the gain codebook 380 according to the index, and outputs the read gain code vector.

The fixed codebook circuit 520 receives an entry of an index showing a delay of an adaptive codebook, creates an adaptive code vector, and outputs an adaptive code vector resulting from multiplying the created adaptive code vector by the gain of the adaptive codebook according to the gain code vector output from the gain decoder circuit 510. In addition, an adaptive codebook component is created based on the past activated sound-source signal.

The sound-source-signal restoring circuit 540 creates a sound-source pulse using an index of a sound-source code vector received from the demultiplexer 505, sound-source signal information and a polarity code vector read out from the sound-source codebook 351, and outputs the sound-source pulse to the adder 550.

The adder 550 creates an activated sound-source signal v(n) based on a mathematical expression (2) shown by Number 2 below using the adaptive code vector output from the fixed codebook circuit 520 and the sound-source pulse output from the sound-source-signal restoring circuit 540, and outputs the activated sound-source signal v(n) to the fixed codebook circuit 520 and the composition filter circuit 560.

$$v ( n ) = {β}_{t}^{′} v ( n - T ) + {G}_{t}^{′} {\sum }_{i = 1}^{M} {g}_{i k}^{′} δ ( n - {m}_{j} ) \qquad ( 2 )$$

The spectrum parameter decoder circuit 570 receives an entry of an index of a spectrum parameter, decodes the spectrum parameter, converts it into a linear prediction coefficient and outputs the coefficient to the composition filter circuit 560 and the coefficient calculator circuit 130.

The composition filter circuit 560 receives entries of the linear prediction coefficient αi output from the spectrum parameter decoder circuit 570 and the activated sound-source signal v(n) output from the adder 550, calculates a reproduction signal x(n) according to a mathematical expression (3) shown by Number 3 below, and output the signal.

$$x ( n ) = v ( n ) - {\sum }_{i = 1}^{10} {α}_{i} x ( n - j ) \qquad ( 3 )$$

### INDUSTRIAL APPLICABILITY

As described above, according to the speech bandwidth extension apparatus and speech bandwidth extension method of the invention, a conventional technique, e.g. HMM, is not used in converting a spectrum parameter into a parameter extended in frequency bandwidth and as such, amounts of calculations can be reduced because of dividing a decoded reproduction speech signal into frames, shifting the frequency of a spectrum parameter determined for each frame to higher one and determining a filter coefficient (linear prediction coefficient) extended in frequency bandwidth.

Further, using a sound-source signal resulting from addition of a noise signal (white noise) with a duration equal to the frame length and an adaptive code vector based on the past sound-source signal enables extremely easy processing with small amounts of information.

The audible timbre can be improved without receiving any information required to carry out a bandwidth extension process from a transmitting end because a speech signal extended in frequency bandwidth is reproduced by passing a sound-source signal through a synthesis filter configured with a filter coefficient extended in frequency bandwidth thereby to make a sound-source signal extended in frequency bandwidth and adding the sound-source signal to a signal resulting from conversion of the reproduction speech signal with a sampling frequency having a higher frequency component.

1. A speech bandwidth extension apparatus characterized by comprising:
a spectrum parameter calculator circuit which receives an entry of a decoded reproduction speech signal and calculates a spectrum parameter indicative of a spectrum characteristic;
a coefficient calculator circuit which shifts a frequency of said spectrum parameter to higher one and then determines a filter coefficient extended in frequency bandwidth;
a voice/voiceless judging circuit which receives an entry of said reproduction speech signal and outputs voice/voiceless judging information and a pitch cycle;
a gain adjusting circuit which outputs a gain based on said voice/voiceless judging information;
a fixed codebook circuit which receives an entry of said pitch cycle and generates an adaptive code vector based on a past sound-source signal;
a noise generator circuit which generates a noise signal limited in bandwidth;
a gain circuit which receives entries of said adaptive code vector and said noise signal and assigns at least one of them a proper gain;
a first adder which adds outputs of said gain circuit to output a sound-source signal; a composition filter circuit which passes said sound-source signal through a synthesis filter configured with said filter coefficient to output a sound-source signal extended in frequency bandwidth;
a sampling frequency converter circuit which receives an entry of said reproduction speech signal and outputs a signal resulting from conversion with a predetermined sampling frequency; and a second adder which adds an output of said sampling frequency converter circuit and an output of said composition filter circuit to output a reproduction speech signal extended in bandwidth.

2. A speech bandwidth extension apparatus characterized by comprising:
a spectrum parameter calculator circuit which receives an entry of a decoded reproduction speech signal and calculates a spectrum parameter indicative of a spectrum characteristic;
a coefficient calculator circuit which shifts a frequency of said spectrum parameter to higher one and then determines a filter coefficient extended in frequency bandwidth;
a voice/voiceless judging circuit which receives an entry of said reproduction speech signal and outputs voice/voiceless judging information;
a gain adjusting circuit which outputs a gain based on said voice/voiceless judging information;
a noise generator circuit which generates a noise signal limited in bandwidth;
a gain circuit which receives an entry of said noise signal and outputs a sound-source signal resulting from assignment of a proper gain;
a composition filter circuit which passes said sound-source signal through a synthesis filter configured with said filter coefficient to output a sound-source signal extended in frequency bandwidth;
a sampling frequency converter circuit which receives an entry of said reproduction speech signal and outputs a signal resulting from conversion with a predetermined sampling frequency; and
an adder which adds an output of said sampling frequency converter circuit and an output of said composition filter circuit to output a reproduction speech signal extended in bandwidth.

3. The speech bandwidth extension apparatus of claim 1, characterized in that said spectrum parameter calculator circuit divides said reproduction speech signal into frames and then calculates and outputs said spectrum parameter indicative of a spectrum characteristic for each frame up to a predetermined order.

4. The speech bandwidth extension apparatus of claim 1, characterized in that said coefficient calculator circuit shifts a frequency of said spectrum parameter to higher one and then converts the resultant spectrum parameter into a filter coefficient (linear prediction coefficient) having a predetermined order to output the filter coefficient.

5. The speech bandwidth extension apparatus of claim 1, characterized in that the fixed codebook circuit receives an entry of said pitch cycle and outputs an adaptive code vector for an adaptive codebook based on a past sound-source signal for each frame.

6. The speech bandwidth extension apparatus of claim 1, characterized in that said noise generator circuit outputs a noise signal which is limited in frequency bandwidth and normalized at a level predetermined in average amplitude and which has a duration equal to a frame length.

7. A speech bandwidth extension method of extending a frequency bandwidth of a decoded reproduction speech signal characterized by:
dividing an entered reproduction speech signal into frames;
shifting a frequency of a spectrum parameter determined for each frame to higher one and then converting the resultant spectrum parameter into a filter coefficient (linear prediction coefficient) extended in frequency bandwidth;
passing a sound-source signal resulting from addition of a noise signal having a duration equal to a frame length and an adaptive code vector based on a past sound-source signal through a synthesis filter configured with said filter coefficient to make a sound-source signal extended in frequency bandwidth; and
adding said extended sound-source signal to a signal resulting from conversion of said reproduction speech signal with a sampling frequency having a higher frequency component, thereby to reproduce a speech signal extended in frequency bandwidth.
